(19) United States
(12) Patent Application Publication
(10) Pub. No.: US 2012/0000951 A1
(43) Pub. Date: Jan. 5, 2012

(54) BIKE FRAME FOR A SEDAN

(75) Inventor: CHING-SHU HUANG, TAINAN CITY (TW)

(73) Assignee: HERN JUEI CO., LTD., TAINAN CITY (TW)

(21) Appl. No.: 12/830,016

(22) Filed: Jul. 2, 2010

(51) Int. Cl. B60R 9/00

(52) U.S. Cl. 224/501

(57) ABSTRACT

A bike frame for a sedan includes a horizontal main frame to be combined with a movable frame by adjusting devices that function to adjust the combined conditions between the main frame and the movable frame. The movable frame is provided with an auxiliary frame serving as a sitting means of combination of the movable frame and the rear side of a sedan. The adjusting devices are respectively disposed with a movable member to be fitted on the main frame, and formed with a receiving notch for receiving the movable frame and provided with a driving member combined with and positioned under the movable member. Further, the adjusting devices respectively have an elastic member for positioning the movable member, and a fit cover for covering all foresaid members and combined together with the main frame and the movable frame.

### BACKGROUND OF THE INVENTION

1. Field of the Invention

This invention relates to a bike frame for a sedan, particularly to one able to be collapsed only by pressing or pulling the pull member on the driving member of an adjusting device. When the driving member is pulled, a movable member will be driven to turn and the protruding wall of the movable member will force the horizontal portion of an L-shaped elastic member to bend upward to actuate a movable frame to move away from the receiving notch of the movable member. By so designing, a user can freely change the combination conditions among the main frame and the movable frame and an auxiliary frame.

2. Description of the Prior Art

A conventional bike carrying frame, as disclosed in a Taiwan patent No. 088202329, titled “BIKE CARRYING FRAME FOR AN AUTOMOBILE”, includes a main frame provided with a main transverse rod extended with a telescopic tube with a plurality of holes. The main frame is further disposed with a lower tube that is vertically fixed thereon with a resisting rod to resist against the rear bumper of a sedan and bored with a hole fixed with a convex-grain spring to be engaged with the holes of the telescopic tube for changing the distance between the lower tube and the upper telescopic tube. The conventional bike frame is provided with a support frame made of a cross-shaped communicating tube, having two symmetrically opposite sides respectively disposed with a placing seat ring and an upper end set with an engage ball to be fixedly engaged with a lower opening of the lower tube of the main frame and further the lower end connected with another integral support frame. The connected two symmetrical placing seat rings are respectively composed of two half rings able to be telescopically combined together and formed with a telescopic structure for connecting the cross-shaped communicating tube, and this telescopic structure is the same as that for combining the telescopic tube of the main frame with the lower tube. Thus, after being combined together, the main frame and the support frame are held and propped up on the trunk of a sedan for carrying a bike thereon. However, to collapse or spread out the conventional bike carrying frame, the telescopic tube of the main frame, the lower tube, the cross-shaped communicating tube of the support frame and the placing seat rings have to be detached one by one, resulting in much trouble in assembling or dissembling.

### SUMMARY OF THE INVENTION

The objective of this invention is to offer a bike frame for a sedan, able to be collapsed or spread out quickly and conveniently without need to detach any member.

The bike frame for a sedan in the present invention includes a main frame, a movable frame and an auxiliary frame that are combined together to form a triangular fulcrum to be combined with the rear side of a sedan by ropes.

The bike frame for a sedan in the present invention is provided with adjusting devices by which the bike frame can easily be spread out for use only by lifting up the main frame to let the movable frame turn downward by gravity and slide into the receiving notches of the movable member. After the bike frame is finished using and is to be collapsed, simple operate the driving members of the adjusting devices to turn the movable member according to set directions and angles and thus, the movable frame can be disengaged from the receiving notches of the movable member.

### BRIEF DESCRIPTION OF DRAWINGS

This invention will be better understood by referring to the accompanying drawings, wherein:

FIG. 1 is an exploded perspective view of a bike frame for a sedan in the present invention

FIG. 2 is a perspective view of the bike frame for a sedan in a spread-out condition in the present invention;

FIG. 3 is a side view of the bike frame for a sedan in a spread out condition in the present invention;

FIG. 4 is a cross-sectional view of the line A-A in FIG. 3;

FIG. 5 is a partial cross magnified view of FIG. 4;

FIG. 6 is a magnified cross-sectional view of the bike frame for a sedan before being collapsed in the present invention;

FIG. 7 is a side view of the bike frame being collapsed in the present invention;

FIG. 8 is a first perspective view of the bike frame being collapsed in the present invention;

FIG. 9 is a second perspective view of the bike frame being collapsed in the present invention;

FIG. 10 is a perspective view of the bike frame in a collapsed condition in the present invention; and

FIG. 11 is a perspective view of the bike frame combined with the rear side of a sedan in the present invention;

### DETAILED DESCRIPTION OF THE PREFERRED EMBODIMENT

A preferred embodiment of a bike frame for a sedan in the present invention, as shown in 1-5, includes a main frame 1, a movable frame 2 and adjusting devices 3 as main components combined together.

The main frame 1 is a horizontal frame that can be in a U-shape or other shapes, and it is illustrated as the U shape. The main frame 1 can be combined with the movable frame 2 by means of the adjusting devices 3, fitted thereon with soft cushions 10 for separating the main frame 1 from the sheet metal of a sedan or an automobile in order not to scrape the sheet metal of the sedan and, if the main frame 1 is made of tubes, the main frame 1 has two ends respectively fixed with a sealing member 11 for preventing water from flowing in the interior of the main frame and dirt from accumulating therein. Further, the sealing members 11 of the main frame 1 can be disposed thereon with a warning or fluorescent lamp for attaining effect of warning and insuring safety.

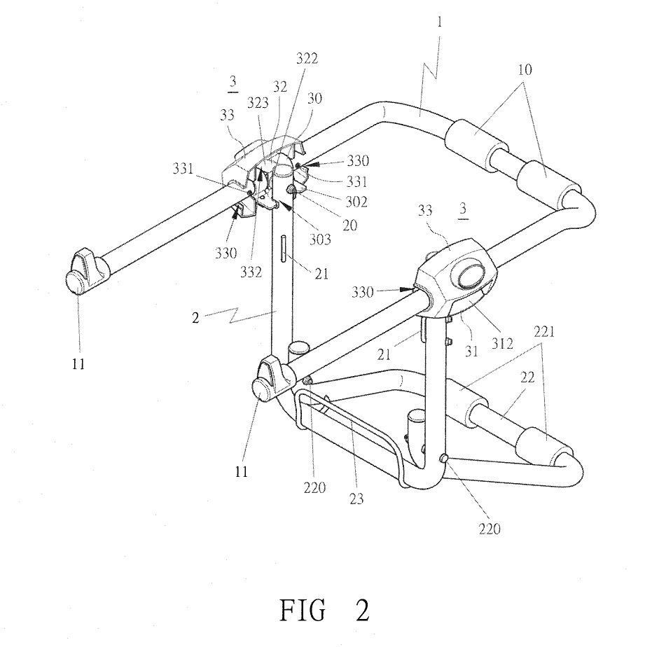

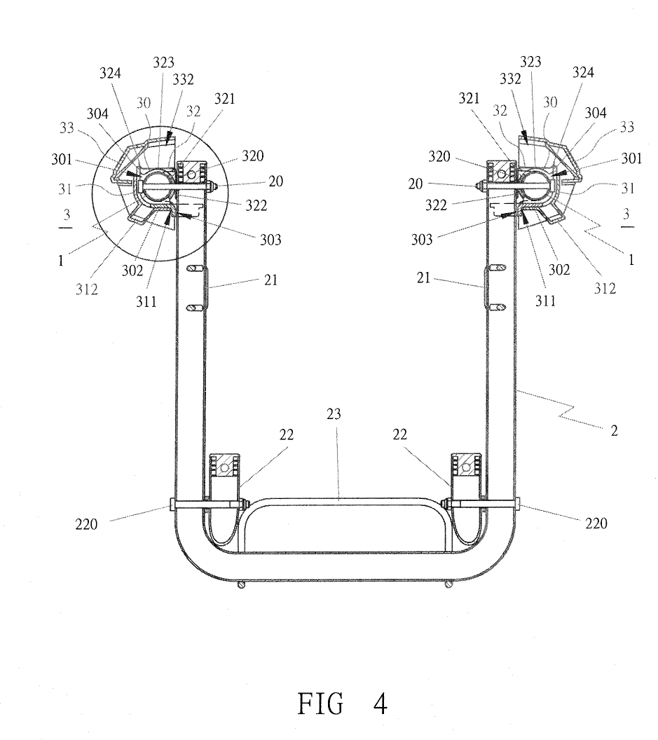

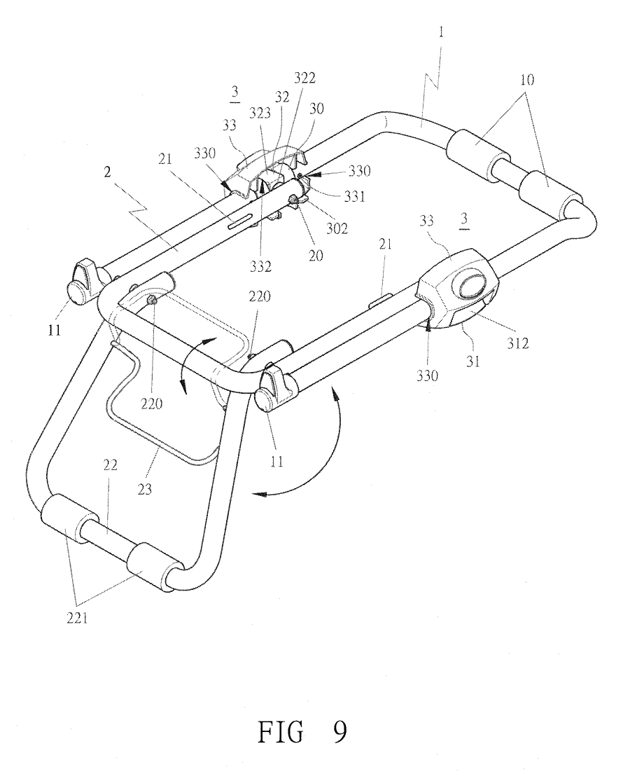

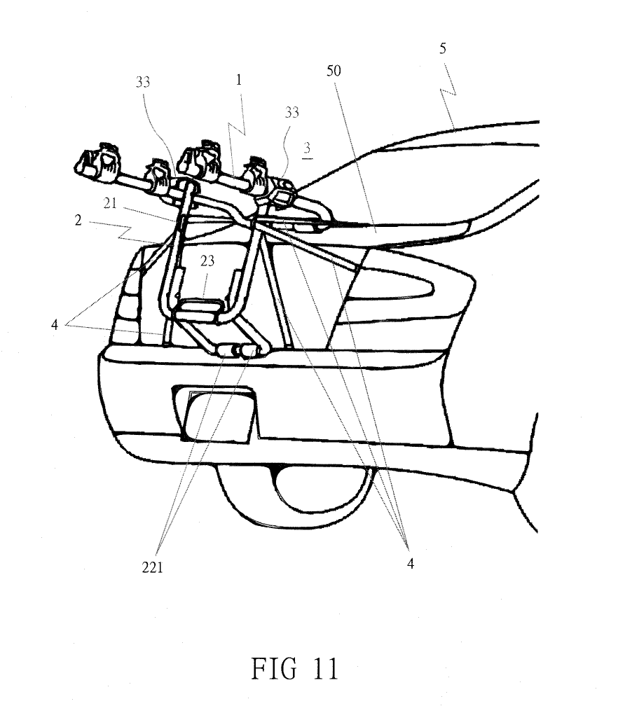

The movable frame 2 can be positioned horizontally or vertically to the main frame 1, as shown in FIGS. 2 and 9, depending on the external looks of the main frame 1 and the movable frame 2 after they are combined together. The movable frame 2 can be formed in a U shape or other shapes, illustrated as the U shape. The movable frame 2 has two ends respectively combined with the main frame 1 by bolts 20, which act as movable pivots of the movable frame 2, as shown in FIGS. 2 and 4, and is provided with a plurality of binding members 21 for ropes 4 to be inserted therethrough and bound with the trunk 50 of a sedan 5, as shown in FIG. 11. The movable frame 2 further has its lower side assembled with a U-shaped auxiliary frame 22 having two free ends respectively and movably combined with the movable frame 2 by means of bolts 220, with the U-shaped auxiliary frame 22 serving as a sitting means for combining with the rear side of a sedan. The auxiliary frame 22 is fitted thereon with soft annular cushions 221 and disposed with an auxiliary positioning rod 23 with a proper curve for limiting the moving space between the movable frame 2 and the auxiliary frame 22 so as to position them properly, as shown in FIGS. 2 and 11.

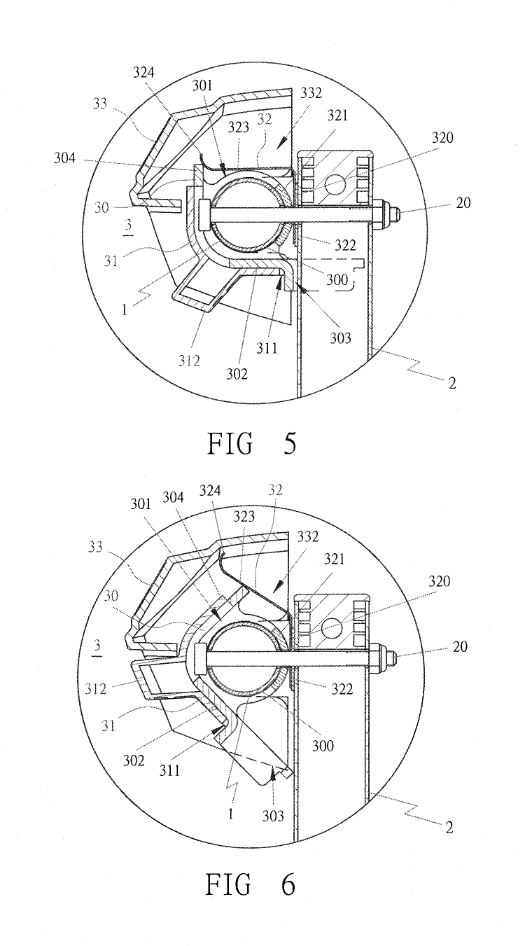

The adjusting devices 3 are respectively mounted between the movable frame 2 and the main frame 1 for adjusting the combined conditions between the main frame 1 and the movable frame 2, respectively provided with a movable member 30 with holes 300 to be fitted with the main frame 1, as shown in FIGS. 4 and 5, and between two adjacent holes 300 is formed an interval space 301. The movable member 30 is formed with a bottom wall 302 that is cut with a receiving notch 303 for engaging the movable frame 2 and further formed with a protruding wall 304. In addition, each adjusting device 3 is disposed with a driving member 31 to be combined with the bottom wall 302 of the movable member 30 by bolts 310 and, due to being similar in shape, the driving member 31 and the movable member 30 can be closely combined together. The driving member 31 is formed with a notch 311 with a shape matching with the receiving notch 303 of the movable member 30 and has one side secured with a pull member 312 for pulling the drive member 31 to drive the movable member 30 to turn a little, as shown in FIG. 6. Each adjusting device 3 is further set with an L-shaped elastic member 32 having its lower vertical portion 320 clamped between the main frame 1 and the movable frame 2 for a bolt 20 to be inserted therethrough. Thus, when the main frame 1, the elastic member 32 and the movable frame 2 are combined together by the bolt 20, the elastic member 32 can be positioned properly and has its upper horizontal portion 323 resisting against the upper side of the protruding wall 304 of the movable member 30, as shown in FIG. 5. The upper horizontal portion 323 of the elastic member 32 has its outer end formed with a curved-up wall 324 by which the elastic member 32 can restrict the movable member 30 to turn to enable the receiving notch 303 of the movable member 30 to engage and position the movable frame 2. Moreover, each adjusting device 3 is provided with a fit cover 33 with an arcuate groove 330 tallying with the exterior of the main frame 1 so that the fit cover 33 can be firmly fitted on the main frame 1 by bolts 331. The fit cover 33 is formed with an interval space 332 for receiving the movable member 30 and covering all the members of the adjusting device 3.

To employ the bike frame of this invention, only hold and lift up the main frame 1 and simultaneously, the movable frame 2, with the bolts 20 acting as pivots and by gravity, will naturally swing downward with circular motion. At this time, the bottom wall 302 of the movable member 30 will be oppressed to turn by the movable frame 2 and its protruding wall 304 will force the upper horizontal portion 323 of the elastic member 32 to bend upward and form incessant rotation potential energy. When swinging downward to a certain angle, the movable frame 2 will be exactly aligned to the receiving notch 303 of the movable member 30, with foresaid incessant rotation potential energy motivating the movable member 30, the receiving notch 303 of the movable member 30 can quickly be engaged with the movable frame 2, thus finishing spreading out the bike frame.

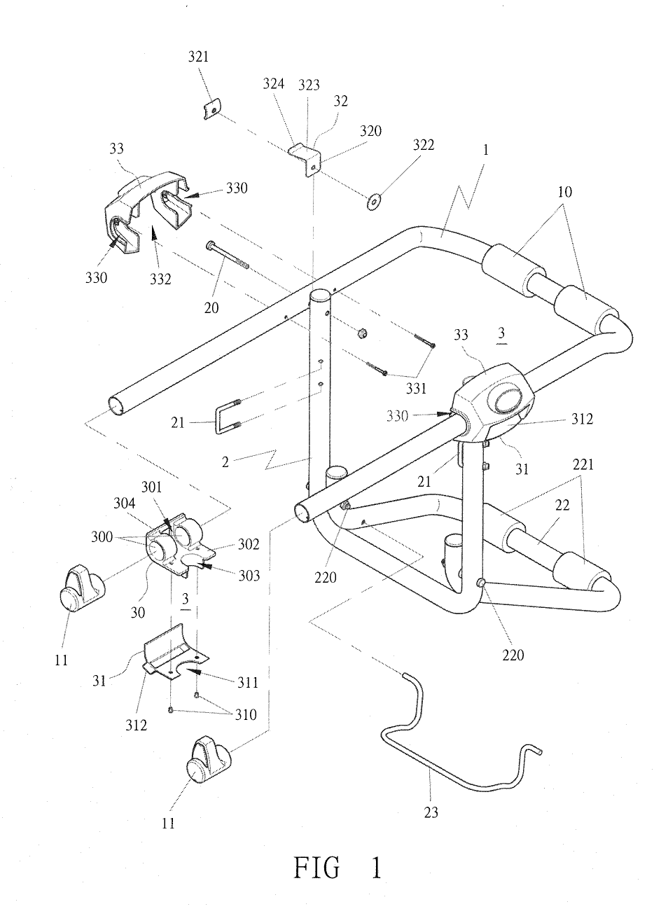

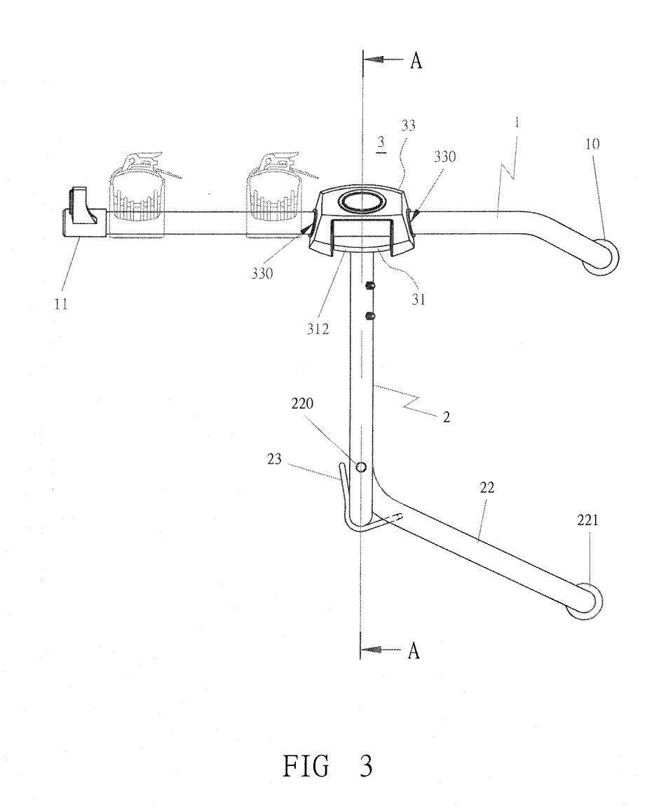

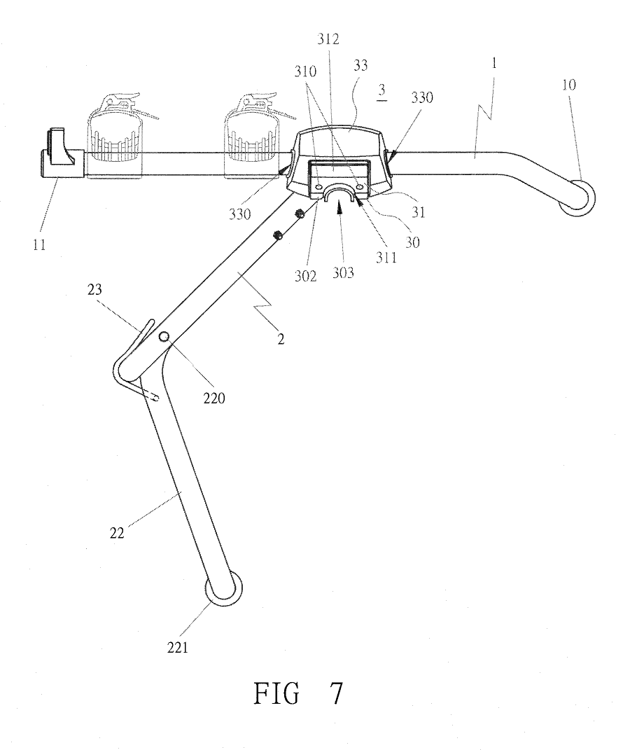

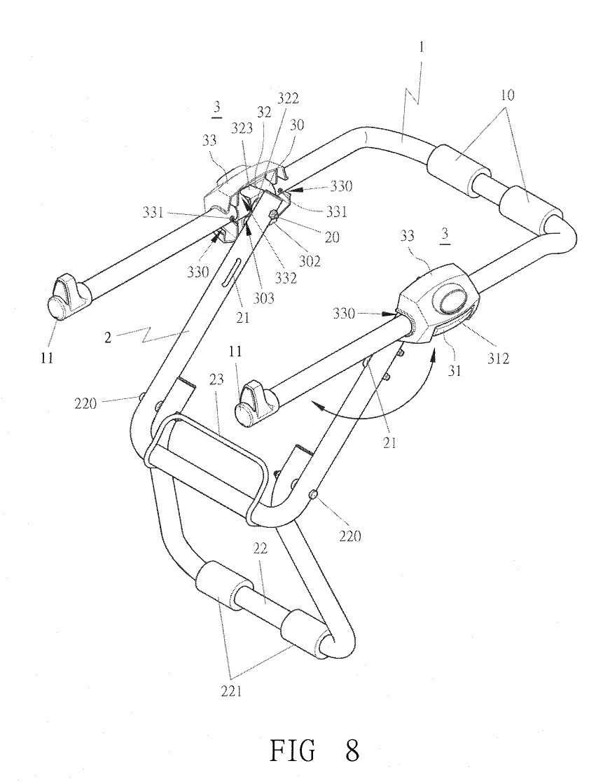

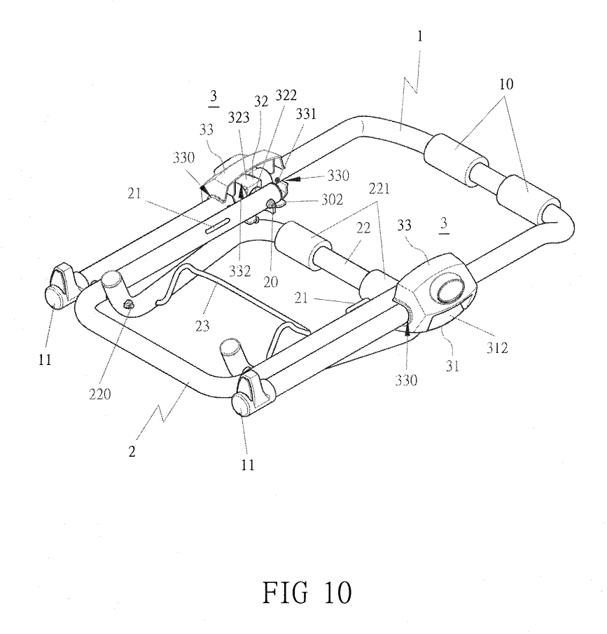

Referring to FIGS. 1-5, after being spread out, the bike frame can be positioned on the trunk 50 of a sedan 5 and firmly bound thereon with ropes 4. To collapse the bike frame, simply press or pull the pull member 312 of the driving member 31 of the adjusting device 3 to actuate the driving member 31 to drive the movable member 30 to rotate, as shown in FIG. 6. Meanwhile, the protruding wall 304 of the movable member 30 will force the upper horizontal portion 323 of the elastic member 32 to bend upward to let the movable frame 2 disengaged from the receiving notch 303 of the movable member 30, as shown in FIGS. 6 and 7, thus finishing collapsing the bike frame and a user able to change the combined conditions among the main frame 1 an the movable frame 2 and the auxiliary frame 22, as shown in FIGS. 8-10.

While the preferred embodiment of the invention has been described above, it will be recognized and understood that various modifications may be made therein and the appended claims are intended to cover all such modifications that may fall within the spirit and scope of the invention.

I claim:

1. A bike frame for a sedan comprising:
a main frame combined with a movable frame by adjusting devices;
said movable frame to be combined with said main frame by said adjusting devices, combined conditions between said main frame and said movable frame able to be adjusted by said adjusting devices;
said adjusting devices respectively provided with a movable member to be fitted on said main frame, said movable member formed with a receiving notch for receiving said movable frame, each said adjusting device disposed with a driving member to be combined with said movable frame, each said adjusting device set with an L-shaped elastic member for positioning said movable member, each said adjusting device provided with a fit cover screwed together with both said main frame and said movable frame and covered on outer sides of foresaid members; and
said main frame lifted up to enable said movable frame to turn downward by gravity and slide into said receiving notch of said movable member, thus able to spread out a bike frame for use, to collapse said bike frame after used, simply operating said driving member of said adjusting device to actuate said driving member to turn according to set directions and angles, letting said movable frame disengaged from said receiving notch of said movable member of said adjusting device.

2. A bike frame for a sedan as claimed in claim 1, wherein said main frame is fitted thereon with soft cushions for separating said main frame from sheet metal of a sedan or an automobile, said main frame disposed with seal members able to prevent water from flowing into an interior of said main frame and also to attain effect of warning and insuring safety.

3. A bike frame for a sedan as claimed in claim 1, wherein said movable frame has two ends respectively combined with said main frame by a bolt, said bolt acting as a movable pivot for said movable frame.

4. A bike frame for a sedan as claimed in claim 1, wherein said movable frame is assembled with an auxiliary frame having two ends movably combined with said movable frame by bolts.

5. A bike frame for a sedan as claimed in claim 4, wherein said auxiliary frame is provided with an auxiliary positioning rod for limiting a moving space between said movable frame and said auxiliary frame.

6. A bike frame for a sedan as claimed in claim 1, wherein said movable member of said adjusting device is bored with holes to be fitted with said main frame.

7. A bike frame for a sedan as claimed in claim 6, wherein said holes are plural and between two of said adjacent holes is formed an interval space.

8. A bike frame for a sedan as claimed in claim 1, wherein said movable member of said adjusting device is formed with a bottom wall that is cut with a receiving notch for receiving said movable frame.

9. A bike frame for a sedan as claimed in claim 1, said driving member of said adjusting device can be combined with said movable member, said driving member formed with a notch with a shape matching with said receiving notch of said movable member.

10. A bike frame for a sedan as claimed in claim 1, wherein said driving member of said adjusting device is provided with a pull member.

11. A bike frame for a sedan as claimed in claim 1, wherein said L-shaped elastic member of said adjusting device is formed with an upper horizontal portion having an outer end disposed with an arcuate wall to enable said upper horizontal portion to resist against an upper side of a protruding wall of said movable member.

12. A bike frame for a sedan as claimed in claim 1, wherein said fit cover of said adjusting device is formed with an arcuate groove matching with an exterior of said main frame.

13. A bike frame for a sedan as claimed in claim 1, wherein said fit cover of said adjusting device is provided with an interval space for receiving said movable member therein.
